(19) United States
(12) Patent Application Publication
(10) Pub. No.: US 2014/0291900 A1
(43) Pub. Date: Oct. 2, 2014

(54) Nozzle System for a Cutting Torch for Autogenous Torch-Cutting with a Sleeve-Like Pipe Jacket for Drawing in Outside Air

(71) Applicants: Alexander Deica, Hunstetten (DE); Wigbert Buhr, Horhausen (DE)

(72) Inventors: Alexander Deica, Hunstetten (DE); Wigbert Buhr, Horhausen (DE)

(21) Appl. No.: 14/355,217

(22) PCT Filed: Nov. 25, 2011
(86) PCT No.: PCT/EP2011/071001

§ 371 Date: Apr. 30, 2014

(51) Int. Cl. B23K 7/00

(52) U.S. Cl. CPC B23K 7/00
USPC 266/48

(57) ABSTRACT

The invention relates to a nozzle system (10) having a nozzle (1) for a cutting torch (3) for autogenous torch-cutting, having a nozzle body (2) with media channels for cutting oxygen, heating oxygen or heating gas for the creation of a primary flow (4). In order to clearly reduce the noise during torch-cutting, the nozzle body (2) is surrounded in a sleeve-like manner by a tube sheathing piece (5). Therein, the inner side of the tube sheathing piece (5) has lengthwise clearances (6) on the sheathing surface of the nozzle body (2) for sucking in outside air using the suction effect of the torch-cutting media for the creation of a secondary flow (7).

### CROSS REFERENCE TO RELATED APPLICATIONS

This application is the U.S. national stage of International Application No. PCT/EP2011/071001 filed on Nov. 25, 2011, and claims the benefit thereof. This application is incorporated by reference herein in its entirety.

### BACKGROUND

The invention relates to a nozzle system for a cutting torch for autogenous torch-cutting of metal workpieces as well as workpieces made from iron alloys, in particular from slabs, blocks and billets, having a nozzle body with media channels for cutting oxygen, heating oxygen or heating gas to create a primary flow.

Oxygen gas cutting torches are provided to cut metal workpieces and workpieces made from iron alloys. Thus, for example, blocks, slabs and billets are cut effectively. Therein, the flame of the cutting gas torch, ignited from the jet of oxygen and cutting gas, is directed onto the surface of the metal to be cut as a primary flow. The metal is thus heated to this ignition temperature, wherein a jet of cutting oxygen oxidises the heated metal in order to effect the cut. Therein, the workpiece begins to combust and forms a seam, which extends to a cut if the jet continues. As heat results from this, this torch-cutting is referred to as autogenous, wherein a further pre-heating of the next metal layers in the position to be cut occurs from the temperature which is achieved from the combusted metal.

It is generally known that the nozzles used for autogenous torch-cutting create considerable free flow noise, particularly due to the supersonic relaxation of the media used (cutting oxygen, heating oxygen or heating gas) with regard to the surrounding atmosphere.

A recognisable reduction of the free flow noise is only achievable via a reduction of the jet speed or a reduction of the operating pressure. Such a solution is, however, not acceptable for technical processing reasons, as the torch-cutting power would thus be considerably reduced.

### SUMMARY

The invention relates to a nozzle system (10) having a nozzle (1) for a cutting torch (3) for autogenous torch-cutting, having a nozzle body (2) with media channels for cutting oxygen, heating oxygen or heating gas for the creation of a primary flow (4). In order to clearly reduce the noise during torch-cutting, the nozzle body (2) is surrounded in a sleeve-like manner by a tube sheathing piece (5). Therein, the inner side of the tube sheathing piece (5) has lengthwise clearances (6) on the sheathing surface of the nozzle body (2) for sucking in outside air using the suction effect of the torch-cutting media for the creation of a secondary flow (7).

### DETAILED DESCRIPTION

The object of the invention is to create a nozzle system for a cutting torch for autogenous torch-cutting of the type named at the beginning, which creates significantly less noise in the case of high torch-cutting power.

According to the invention, the object is solved in that the nozzle body is surrounded in a sleeve-like manner by a tube sheathing piece, wherein the inner side of the tube sheathing piece has lengthwise clearances on the sheathing surface of the nozzle body for sucking in outside air using suction effect of the torch-cutting media for the creation of a secondary flow.

Due to the lengthwise clearances on the inner side of the tube sheathing piece, gaps form towards the outer sheathing surface of the nozzle body. The cutting flame formed by the torch-cutting media creates a pulling effect, such that outside or ambient air is sucked in via the lengthwise clearances, so the gaps between the tube sheathing piece and the nozzle body, and thus a secondary flow is created at the front outlet end. This occurs in that the primary flow is further accelerated to supersonic speed after leaving the nozzle, and thus sets into motion the additional secondary flow from the outside or ambient air using the pulling effect.

The secondary flow serves to soften the primary flow in its expansion. At the same time, the sound expansion in the ambient atmosphere is minimised and thus the noise during torch-cutting is reduced without negatively influencing the torch-cutting power.

Furthermore, the secondary flow ensures the required cooling of the used tube sheathing piece, which also fulfils an additional protective function of the nozzle against deterioration and contamination, in particular from slag, beads of sweat and contaminant particles.

In a further embodiment of the invention, the sleeve-like tube sheathing piece hangs over the front outlet end of the nozzle body. Thus, the formation of the secondary flow is optimised and is brought to the required flow speed.

According to a further embodiment of the solution according to the invention, the front side is cut off in a straight line at the front outlet end of the tube sheathing piece.

Alternatively to this, the front side is cut off in a serrated, waved or notched manner at the front outlet end of the tube sheathing piece. Thus, further noise reduction is achieved. Additionally, an additional air flow is included with the primary flow and secondary flow.

### BRIEF DESCRIPTION OF THE DRAWINGS

The underlying concept of the invention is described in more detail in the following description by means of exemplary embodiments which are depicted in the drawings. Here are shown:

FIG. 1 a nozzle system according to the invention for a cutting torch for autogenous torch-cutting in a first embodiment,

FIG. 2 a nozzle system for a cutting torch for autogenous torch-cutting in a second embodiment and

FIG. 3 a sectional view of a tube sheathing piece, applied to a nozzle according to FIGS. 1 and 2.

### DETAILED DESCRIPTION OF THE PREFERRED EMBODIMENT

The nozzle system 10 consists fundamentally of a nozzle 1 having a nozzle body 2 which is fixed on the front end of a cutting torch 3 for autogenous torch-cutting. A cutting flame for torch-cutting is created using media channels that are not depicted in more detail for cutting oxygen, heating oxygen or heating gas in the nozzle 1 and in the cutting torch 3. Thus a primary flow 4 is formed on the front outlet end of the nozzle 1.

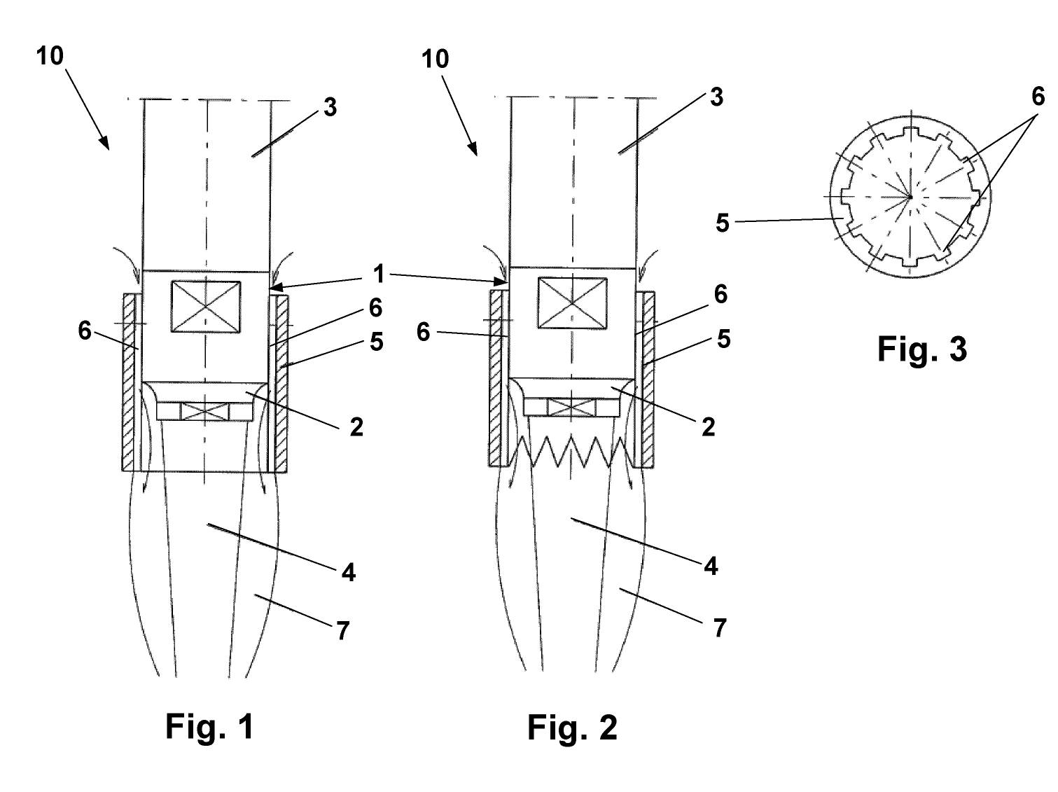

According to FIGS. 1 and 2, the nozzle body 2 is surrounded in a sleeve-like manner by a tube sheathing piece 5, which hangs over the front outlet end of the nozzle 1. This has lengthwise clearances 6 on its inner side, as is also evident from FIG. 3. Using these clearances 6 between the sheathing surface of the nozzle body 2 and the tube sheathing piece 5, outside or ambient air is sucked in using the suction effect of the torch-cutting media. Thus, in turn, a secondary flow 7 is created around the primary flow 4.

In the case of the embodiment of the nozzle system 10 according to FIG. 1, the front side is cut off in a straight line at the front outlet end of the tube sheathing piece 5. However, in the case of the embodiment of the nozzle system 10 according to FIG. 2, the front side is formed to be serrated on the front outlet end of the tube sheathing piece 5.

### LIST OF REFERENCE NUMERALS

10 Nozzle system

1 Nozzle

2 Nozzle body

3 Cutting torch

4 Primary flow

5 Tube sheathing piece

6 Clearances

7 Secondary flow

1. Nozzle system having a nozzle for a cutting torch for autogenous torch-cutting of metal workpieces as well as workpieces made from iron alloys, in particular from slabs, blocks and billets, having a nozzle body with media channels for cutting oxygen, heating oxygen or heating gas for the creation of a primary flow, characterised in that the nozzle body is surrounded in a sleeve-like manner by a tube sheathing piece, wherein the inner side of the tube sheathing piece has lengthwise clearances on the sheathing surface of the nozzle body for sucking in outside air using the suction effect of the torch-cutting media for the creation of a secondary flow.

2. Nozzle system according to claim 1, characterised in that the sleeve-like tube sheathing piece hangs over the front outlet end of the nozzle body.

3. Nozzle system according to claim 1, characterised in that the front side is cut off in a straight line at the front outlet end of the tube sheathing piece.

4. Nozzle system according to claim 1, characterised in that the front side is cut off in a serrated, waved or notched manner at the front outlet end of the tube sheathing piece.
